(19) United States
(12) Patent Application Publication
(10) Pub. No.: US 2014/0376639 A1
(43) Pub. Date: Dec. 25, 2014

(54) ROTATION-BASED MULTIPLE DESCRIPTION VIDEO CODING AND DECODING METHOD, APPARATUS AND SYSTEM

(71) Applicant: Beijing Jiaotong University, Beijing (CN)

(72) Inventors: Yao Zhao, Beijing (CN); Chunyu Lin, Beijing (CN); Huihui Bai, Beijing (CN)

(21) Appl. No.: 14/369,210

(22) PCT Filed: Nov. 7, 2012
(86) PCT No.: PCT/CN2012/084216

§ 371 Date: Jun. 27, 2014

(30) Foreign Application Priority Data
Dec. 27, 2011 (CN) 201110444699.7

(51) Int. Cl. H04N 19/39; H04N 19/60

(52) U.S. Cl. CPC H04N 19/0046; H04N 19/00775
USPC 375/240.18

(57) ABSTRACT

A rotation-based multiple description video coding and decoding method, apparatus and system. The coding method comprises the following steps: extracting one frame f in a video sequence; carrying out symmetric transformation on the frame f, and then performing H.264 coding to obtain a description 1; and directly performing H.264 coding on the original frame f to obtain a description 2. The present invention also provides a redundancy adjustment coding method and a corresponding decoding apparatus and system. The method, apparatus and system of the present invention can be used for signal coding and decoding of multimedia information in an environment where error codes occur frequently.

### TECHNOLOGY FIELD

The present invention relates to the video encoding and decoding field, particularly to a multiple description video encoding and decoding method, apparatus and system based on rotation.

### PRIOR ART

In recent years, with the development of Internet and widespread of every kinds of wireless terminals, multimedia transmission in the error prone network gets more and more attention. The current network is a so-called “best effort”, in which channel disturbance, network congestion and route delay, etc. exists. These problems result in data error and packet loss. In addition, with random bit error and consecutive burst error, wireless channel further aggravates the transmission environment. All these problems will result in the decoding failure of the whole bit stream or part of the bit stream at least. For the video coding, H.264/AVC standard or other MPEG standard, is employed generally, one packet lost will affect the other following packets due to the motion estimation and compensation. Hence, these problems have become the bottleneck of multimedia transmission.

Multiple description coding (MDC) is an effective scheme to solve the above problems. MDC assumes that there are more than one independent channel between the signal and the receiver. If the probability that one channel fails is p, then the probability that n channels fail will be pⁿ. By generating n equally important descriptions for the same source signal that can be decoded independently, it can reconstruct an acceptable quality for the signal when some descriptions are lost. In the meantime, the more the descriptions are received, the better quality the reconstructed signal could be. For convenience, the decoding process for each single description is called side decoding, while the decoding process when all the descriptions are received is called central decoding. Because the decoding can be finished with only a part of information even though not all the descriptions are received, MDC is widely used in audio coding, image coding, video coding, distributed storing system and other low-delay coding systems. Different from the layer coding, there is no difference between different descriptions, in contrast with the base layer and enhancement layer in layer coding system. In fact, all of the descriptions are with the same importance. Hence, it is very suitable in the current internet that with no priority protection. Compared with forward error correction (FEC) and Automatic Error Request (ARQ), MDC can meet the real-time requirement.

As known, the conventional video coding technology uses the temporal relevance between the close frames to improve ability to compress the video data. Hence, almost all of the video encoding systems employ motion estimation and motion compensation. However, this will result in mismatch in MDC. The mismatch means that the reference frame (block/pixels) used in the decoding end/side and encoding end/side are different due to the packet loss. The simplest solution for controlling the mismatch is carrying out the independent prediction loop for each description. The general way is to subsample the video sequence into even/odd frames firstly. Then the subsampled sequences are encoded and decoded independently, with their independent prediction loop. When only one description is received, the subsampled frames will be interpolated to generate the lost description. When both of the two descriptions are received, each description is decoded and combined to reconstruct the final signal. Similarly, there is also spatial subsampling. This kind of MDC schemes is easy to implement and can be applied in any standard video coding system. However, its redundancy adjustment is not flexible. In addition, due to the subsampling, the relevance between different pixels or different frames is less than before. Hence, the compression of residual signal will be less efficient. Vaishampayan uses joint-quantization in the two prediction loops to avoid the mismatch. However, the compression efficiency is lower due to the coarse quantization. Another kind of mismatch controlling methods is to encode the mismatch signal again, that is, encode the mismatch between the central description and side description and distribute this information to the two descriptions. The mismatch could be controlled by this way, however, the structure is too complex and the redundancy is too much compared with other methods. When both of the two descriptions are received, the mismatch information is useless. Another kind of schemes use the redundancy slice in H.264, by optimizing the quantization steps between original slice and redundancy slice, this kind of schemes can be compatible with H.264 standard. Its performance is also very good.

All of the above schemes either try to exploit the redundancy existed in the video, such as spatial subsampling, or try to insert some redundancy, such as the scheme based on redundant slices. When only one description is received, its reconstructed quality is worse than its corresponding single description. In addition, the change of the standard encoder is required most of time to meet the MDC. Hence, the complexity of MDC scheme is increased and it is not standard compatible.

### SUMMARY OF THE INVENTION

The object of the present invention is to provide multiple description video coding and decoding method, apparatus and system based on rotation, which can solve the complexity problem in MDC and its performance.

Thus, according to the first aspect of the present invention, there provides a multiple description video coding method based on rotation, characterized in that said method includes the following steps:
extracting one frame f from the video sequence;
carrying out a symmetric transform on the frame f, encoding it with H.264 to form a description 1; and
encoding the original frame f directly with H.264 to form a description 2.

Preferably, said method further includes the following sub-steps:
getting a reconstructed frame f′ of the description 1 and carrying out an inverse symmetric transformation, then averaging the transformed frame with the reconstructed frame f″ of the description 2;
subtracting the original frame f from the averaged frame to get a residual;
encoding the residual with H.264; then
subsampling the residual from even/odd parts so as to form a description 3 and a description 4, respectively.

According to the second aspect of the present invention, there provides a multiple description video decoding method based on rotation, characterized in that said method includes:

if two packets of the same image content, which belongs to the two descriptions, are not all lost, carrying out the reconstructed pixel of the received packet to replace the lost one, in which the displayed pixels at a decoding side are the average values of the two descriptions; and both of the two descriptions use their original corresponding reference image to decode; or

if both the packets of the same image content in the two descriptions are lost, carrying out a default concealment technique in H.264 to reconstruct the pixels at the decoding side, in which the displayed pixels are still the average ones of the two descriptions, and the reference image is changed as the average reconstructed one for both of the two descriptions.

Preferably, at the decoding side, the decoding for each of descriptions 1 and 2 are still implemented as claim 4; for description 3 and 4, the decoded residual will be added to the descriptions 1 and 2 respectively to finish the reconstruction.

According to the third aspect of the present invention, there provides a multiple description video coding apparatus based on rotation, characterized in that the apparatus includes the following modules:
a frame storing module for storing each of frames f from the sequence;
a symmetric transformation module for carrying out the symmetric transformation for each of frames f;
a H.264 module for carrying out the transformation with H.264 for the original frame and the frame after the symmetric transformation;
a description 1 module for storing the description 1 after H.264 transformation; and
a description 2 module for storing the description 2 after H.264 transformation.

Preferably, the apparatus includes the following modules:
a reconstructed frame f′ module for reconstructing the description 1;
an inverse symmetric transformation module for carrying out the inverse symmetric transformation for the reconstructed frame f′;
a reconstructed frame f″ module for reconstructing the description 2;
an average module for averaging the reconstructed frame f′ and the reconstructed frame f″;
an extracting residual module for getting the residual between the outputs of average module and the original frame;
a residual H.264 encoding module for encoding the residual with H.264;
a data packet subsampling module for subsample the data output from the residual H.264 encoding module in even/odd way;
a description 3 module for storing the odd parts of the output in the subsampling module; and
a description 4 module for storing the even parts of the output in the subsampling module.

According to the fourth aspect of the present invention, there provides a multiple description video decoding apparatus based on rotation, characterized in that the apparatus includes the following modules:
a judgment module for checking whether data packets of both of the two descriptions that contain the same content as each other are lost;
a reconstructed module for using the received data packet to replace the lost data packet to reconstruct the lost data packet if the data packets of the two descriptions that contains the same content as each other are not both lost; at the decoding side, the displayed image is the average value of the two descriptions; both of the two descriptions use their original reference frames; on the other hand, if neither of the data packets of the two descriptions that contain the same image content as each other is received, the lost packets are reconstructed with error concealment technique in H.264, while the display at the decoding side is still the average value of the two descriptions, and both of the two descriptions use the average reconstructed frame as the reference.

Preferably, the apparatus further includes the following modules:
a residual decoding module for decoding the residual signal; and
an adding module for adding the decoded residual to the description 1 and the description 2.

According to the fifth aspect of the present invention, there provides a multiple description video decoding system based on rotation, characterized in that, the system includes the coding apparatus and the decoding apparatus.

Due to the use of symmetric transform based MDC algorithm in the present invention, each macroblock of each frame of each of the two descriptions uses its own different reference as prediction, so the generated residual will be different. Hence, the system according to the present invention is simple and efficient.

### BRIEF DESCRIPTION OF ACCOMPANYING DRAWINGS

Through the following description with the appended figures, it can be easy to understand the present invention, as well as its advantages. But the included figures are used to provide further understanding of the present invention, it belongs to the present invention. It is used to describe the invention and the present invention is not limited to these figures alone.

FIG. 1 is a schematic view of an encoding side of a multiple description system based on rotation.

FIG. 2 is a schematic view of a multiple description encoding side with redundancy adjustment based on residual.

FIG. 3 is a schematic view of the corresponding packets after symmetric transform.

FIG. 4 is a schematic view of the decoding process when the only one description of the same content is lost;

FIG. 5 is a schematic view of the decoding process when the both of the two descriptions of the same content are lost;

FIG. 6 is a schematic view of side and central performance comparison of multiple description encoding results;

FIG. 7 is a schematic view of the performance comparison of different packet loss rates of encoding results of the multiple description system.

### BEST MODE FOR CARRYING OUT THE PRESENT INVENTION

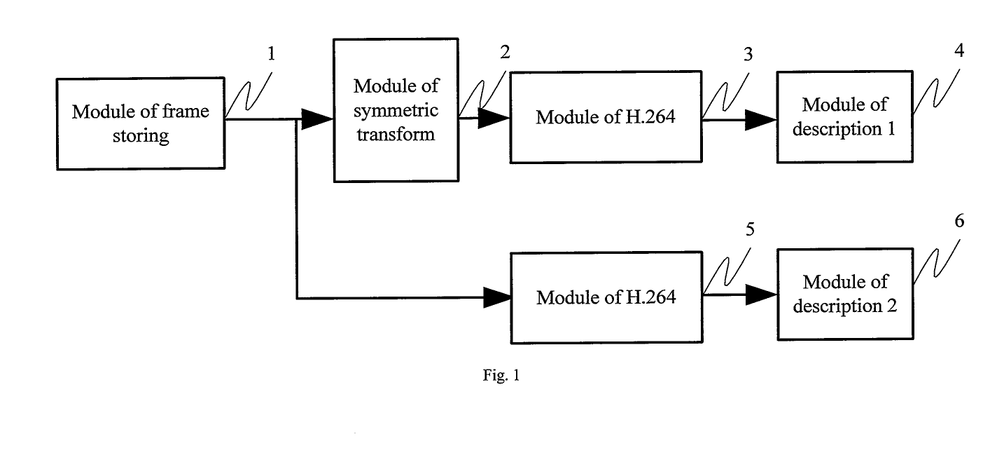

In the following, embodiments of the present invention will be described with FIGS. 1-7.

To make the above object, features and advantages to be more obvious and easy to be understood, the present invention will be further explained with the figures.

### Example 1

FIG. 1 shows the encoding side of the multiple description system based on rotation. In the following, all the steps are operated on each frame in the sequence. For convenience, each description is explained separately. Each frame of the video sequence is encoded with H.264 to form one description. In the meantime, each frame is rotated with 180 degree and encoded with H.264 to form another description.

This rotation-based multiple description encoding system tries to make each macroblock in each description exploit different reference macroblock. Then the generated residual for each description will be different. Hence, a rotation with 180 degree is just one example here, other transform such as flip and mirror etc. can also be employed. When both of the two descriptions are received, use the average values in the pixel domain as the reconstructed value of central performance. If the residual for the two descriptions are closed to uncorrelated or negative correlated, then the central performance can get higher gain compared to side description. Its theory model is: use f as the original frame, and \hat{f}₁ and \hat{f}₂ are reconstructed frame for the two descriptions respectively. Let P denote the prediction part, Q denote the quantization part, e represent the quantization error. Then the two multiple descriptions for the invention are as follows. That is, for each macroblock of the current f, the two descriptions use different reference frame or reference macroblock, result in different residual, and finally generate different quantization errors e₁(n) and e₂(n).

The corresponding central reconstruction is:

\hat{f}(n)=0.5(\hat{f}₁(n)+\hat{f}₂(n))=f(n)−0.5(e₁(n)+e₂(n))

The more uncorrelated or close to negative correlated e₁(n) and e₂(n) are, then the smaller the error will be to get \hat{f}(n).

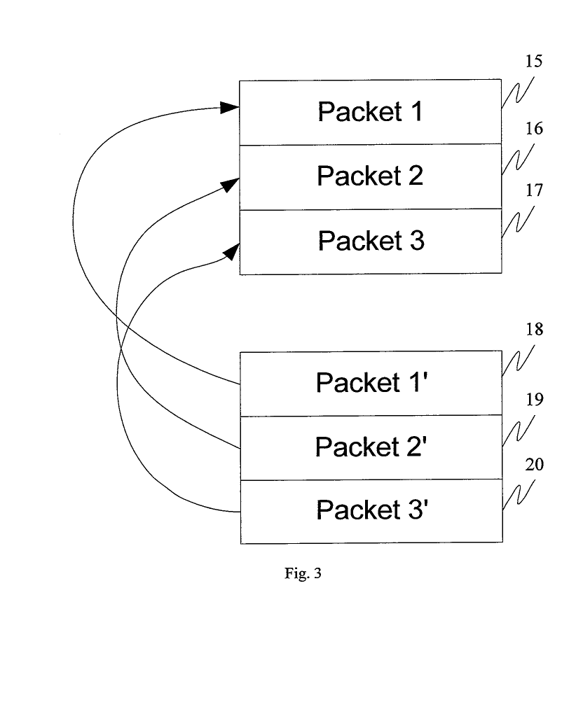

When a part of data packet in one description is lost, the system will use the corresponding packet in the other description to replace the lost packet. Since the two descriptions use the same bit rate and the same encoding method, the distortions of the two descriptions will have the same mean and variance. Hence, the mismatch error due to the replacement will be reduced significantly. FIG. 3 shows the packet process for original image and rotated image. Packets 15, 16, 17 in the original frame correspond to packets 18, 19, 20 after being related. This kind of organizing process of packets can make sure that one packet in a description can find its corresponding one in the other description. Hence, when certain packet is lost in one description, it can find the other packet in the other description to replace it.

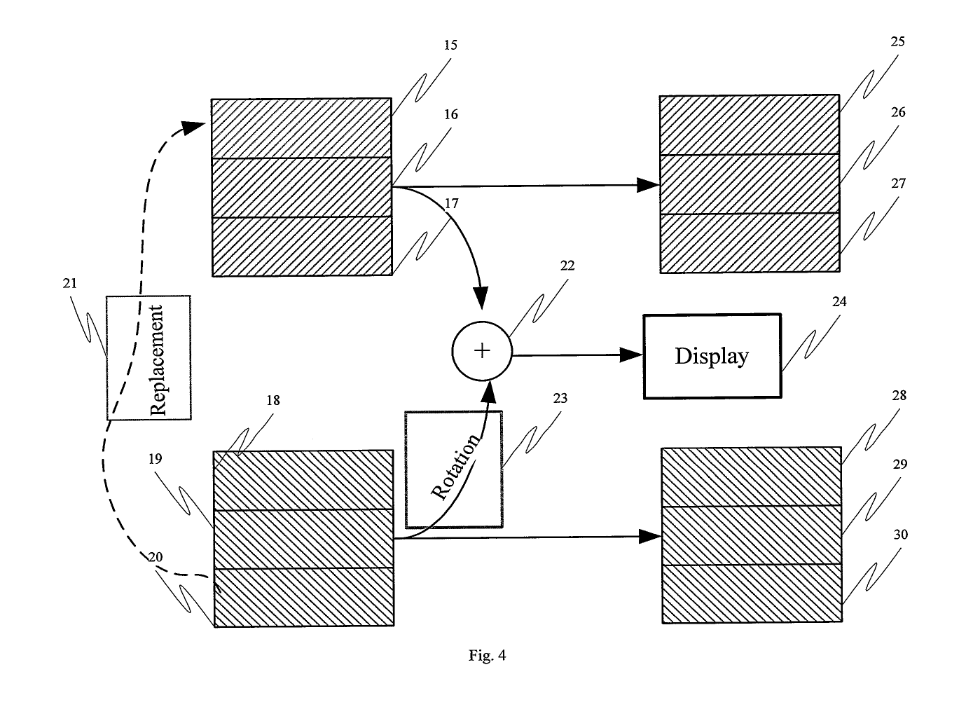

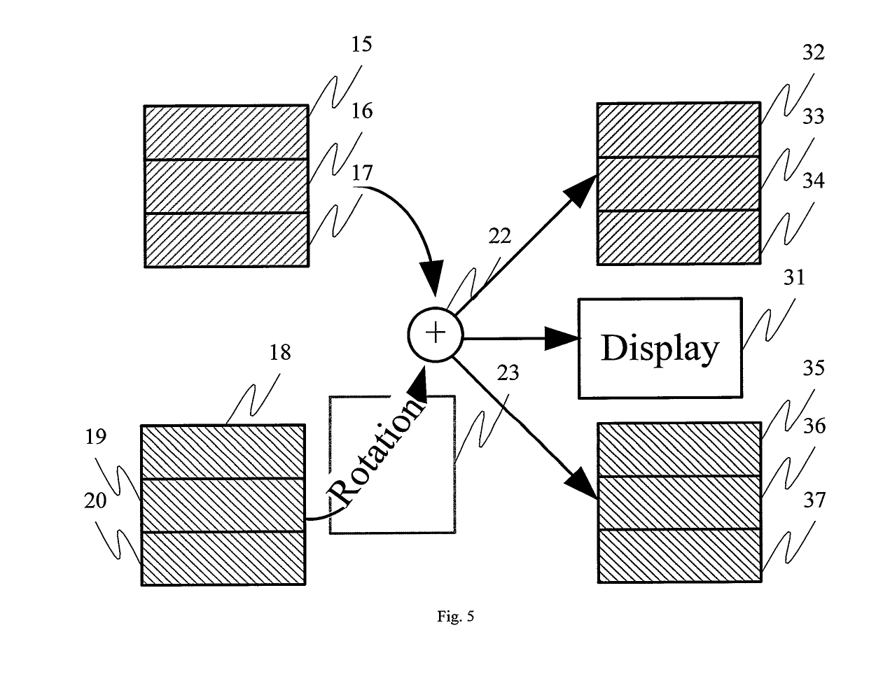

There are two situations for the decoding end. As shown in FIG. 4, the first case is that not both of the two descriptions are lost. In the figure, packet 15 and packet 20 denote the lost packet, while packets 16, 17, 18 and 19 are the received packet. Hence, the lost packets will be replaced by their corresponding received packets. The displayed 24 at the decoding side is reconstructed by averaging 22 and 23, in which 22 is obtained by decoding 15, 16 and 17 while 23 is obtained by decoding packet 18, 19 and 20 and inverse rotation 23. Hence, the decoded quality is better. Notice that both of the two descriptions still use their original reference frame, that is, the reference frame packets 25, 26 and 27 will be reconstructed from packets 15, 16 and 17; while reference frame packets 28, 29 and 30 will be reconstructed from packets 18, 19 and 20. Hence, the mismatch (i.e. the reference block used in the encoding side is different to that used in the decoding side) will be prevented. As shown in FIG. 5, in the second case, both of the packets containing the same video content in the two descriptions are lost. In this case, use the error concealment technique at the decoding end with H.264 to reconstruct the image. In the decoding end, the displayed 31 still uses the average of 22 and rotated 23, in which 22 and 23 are reconstructed from descriptions 15, 16, 17 and descriptions 18, 19, 20. However, both of the two descriptions use the averaged frame as their reference frames 32, 33, 34, 35, 36, and 37, It is because that the average value of reference frames 32, 33, 34, 35, 36, 37 is better than any single reconstructed frame and will reduce the mismatch error further.

A multiple description video encoding method that includes the following step:
a. Extract a frame f from the video sequence;
b. Carry out a symmetric transform for f and encode it with H.264 encoding to get a description 1;
c. Encode the original frame f with H.264 encoding to form description 2.

The invention also provides a multiple description video decoding method that includes the following step:
a. If not both of the two descriptions containing the same video content are lost, use the received packet to replace the lost one to reconstruct the signal. The displayed frame at the decoding end/side is the average of the two descriptions. Both of the two descriptions still use their original reference frame
b. If both of the packets containing the same video content in the two descriptions are lost, use the error concealment technique at the decoding end with H.264 to reconstruct the image. In the decoding end, the displayed frame still uses the average of two descriptions. However, both of the two descriptions use the averaged frame as their reference frame.

The present invention also provides a multiple description encoding apparatus based on rotation, which includes the following modules:
a frame storing module 1 for storing each frame f in the sequence;
a symmetric transforming module 2 for carrying out the symmetric transform for every frame f;
H.264 modules 3 and 5 for encoding the original frame or the transformed frame with H.264;
a Description 1's module 4 for storing description 1 after H.264 encoding; and
a Description 3's module 6 for storing description 2 after H.264 encoding.

The present invention also provides a multiple description decoding apparatus based on rotation, which includes the following modules:
a judgment module for checking if both of the two descriptions that contain the same video content are lost;
a reconstructed module, if not both of the two descriptions that contains the same video content are lost; use the received one to replace the lost one to reconstruct the signal. In the decoding end, the displayed image is the average value of the two descriptions; both of the two descriptions use their original reference frames. If neither of the two descriptions that contain the same image content is received, the lost packets will be reconstructed with error concealment technique at the decoding side in H.264, while the decoder will display the average value of the two descriptions. Both of the two descriptions will use the average reconstructed frame as the reference.

### Example 2

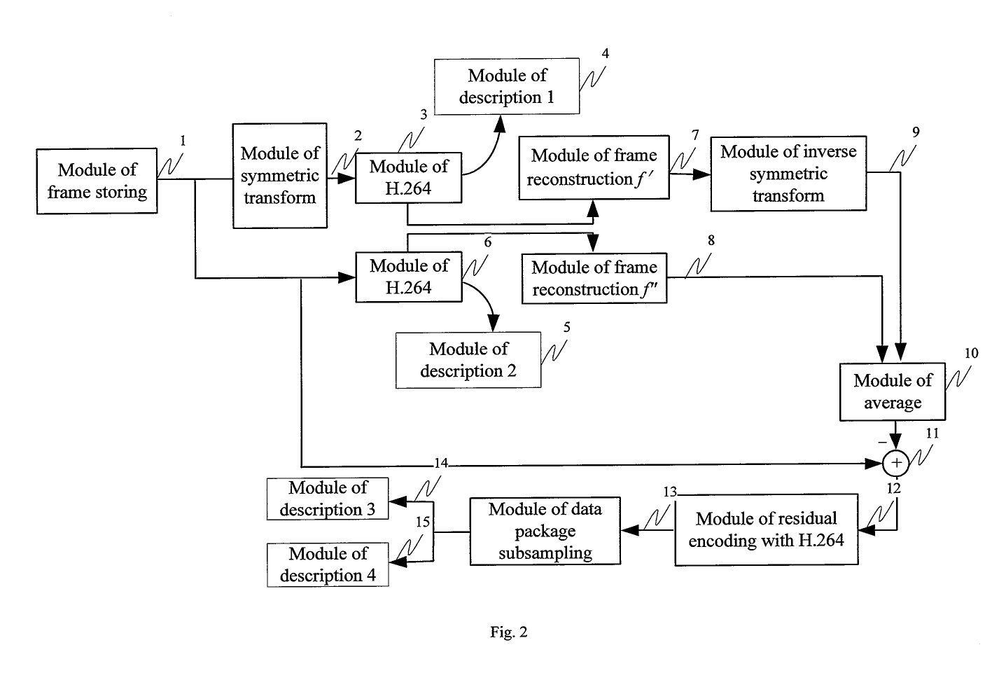

To further tune the redundancy, calculate the residual between the original frame and the average value. Encode the residual signal with H.264. After that, subsample the packets according to even/odd way to form the second part of each description. The new encoding system is shown in FIG. 2. In the decoding end, for the first part, each description still uses its original decoding way; for the second part, the reconstructed residual will be added to the first part of each description to complete the reconstruction.

With the fixed total bitrate for each of the two descriptions, when the channel condition is good, the probability that the two descriptions are both received is larger, hence more bits should be distributed on the residual signal. And the whole system tends to provide a good central performance. When the channel condition is not stable, only one description is received most of time with high probability, fewer bits should be assigned to the residuals at this case. In the extreme case, if both of the two descriptions are reliable, the whole system will become encoding the sequence with H.264 and sending the packets alternatively in the two channels, that is only description 3 and descriptions 4 are kept in the system. In contrast, the whole system will only contain description 1 and description 2, with more redundancy to protect the data when the channel conditions are not good.

Preferably, a multiple description video encoding method includes the following steps:
a. Get the reconstructed f′ of the description 1 and carry out the inverse symmetric transform, average it with the reconstructed frame f″ of the description 2;
b. Get a residual between original frame f and the average output;
c. Encode the residual with H.264;
d. Subsample the H.264 encoded residual packets by even/odd way to form descriptions 3 and 4;

Preferably, a multiple description video encoding apparatus includes:
a reconstructed frame f′ module 7 for reconstructing the description 1;
an inverse symmetric transform module 9 for carrying out the inverse symmetric transform for the reconstructed frame f′;
a reconstruct frame f″ module 8 for reconstructing the description 2;
an average module 10 for averaging the reconstructed frame f′ after inverse symmetric transform with the reconstructed frame f″;
an extracting residual module 11 for getting the residual between original frame and the averaged reconstructed value;
a module 12 of H.264 encoding for the residual for encoding the residual with H.264;
a packet subsampling module 13 for subsampling the encoded residual packets by even/odd way;
a description module 14 of the description 3 for storing the odd part from the subsampling; and
a description module 15 of the description 4 for storing the even part from the subsampling.

Preferably, in a multiple description video decoding apparatus, each description for description 1 and description 2 is still decoded by the original way; for description 3 and description 4, the decoded residual will be added to the decoded description 1 and 2 respectively to complete the reconstruction.

### Example 3

The present invention also provide a rotation based multiple description video decoding system, which includes the above encoding apparatus and decoding apparatus.

### Example 4

This example adopts the H.264 JM as the software to generate the encoded bit stream. It uses the fixed number of macroblocks to organize the packet. For simplicity, it can take one row of the frame as one packet. In this way, the packets containing the same video content from normal encoded video packets and the inverse encoded rotated video packets can be easily found. The GOP structure of H.264 is IPPP, that is, only the first frame is I frame and others are all P frame. The tested video sequence is CIF format for Foreman sequence.

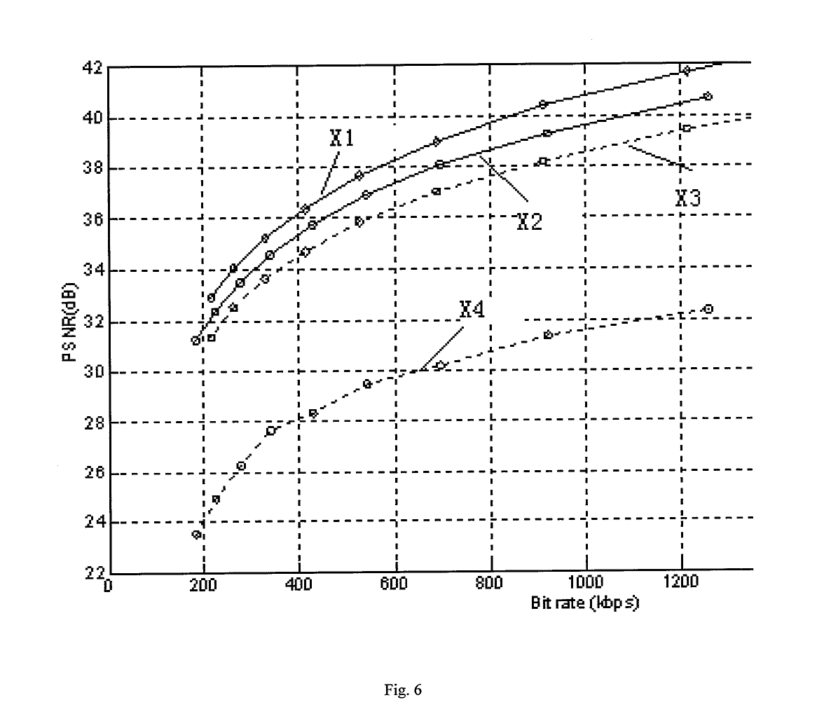

FIG. 6 presents the results for a central description in PSRN for receiving both of the two descriptions and a side description in PSRN for receiving one of the two descriptions. For comparison, the results in RS-MDC based on redundant slice are also provided. Both of the two schemes use the same GOP size 45. It can be seen that X1, X2, X3, X4 represent the proposed central description, the central description of RS-MDC, the proposed rotated side description, the side description of RS-MDC respectively. The multiple description coding system based on rotation has better results than that of RS-MDC. Since RS-MDC has very completive performance in all the existing RS-MDC schemes, it demonstrate the good performance of the proposed.

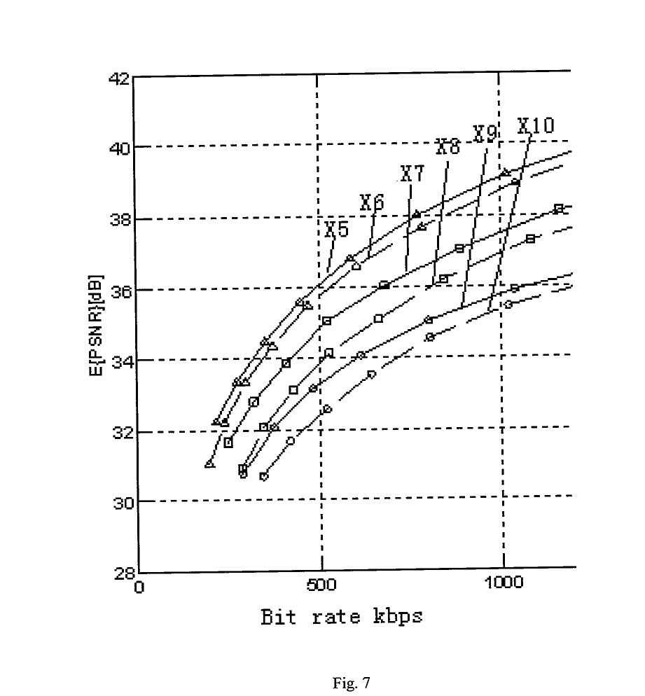

FIG. 7 presents the results at different packet loss rate and different GOP conditions, compared with RS-MDC. The GOP sizes are 11, 21 and 45, while the packet loss rates are 1% , 5% and 10%. X5, X6, X7, X8, X9, X10, X11 and X12 represent the proposed rotated MDC scheme (p=0.01, N=45), RS-MDC scheme (p=0.01, N=45), MDC scheme (p=0.05, N=21), RS-MDC scheme (p=0.10, N=11), and RS-MDC scheme (p=0.10, N=10). These parameters are selected to coincide with RS-MDC for fair comparison. It could be seen that the proposed MDC schemes are much better than that of RS-MDC.

As mention above, the present invention has been described with the examples in detail. But there could be other embodiments obvious for those skilled in the art that do not go beyond the spirits from the essence of the present invention. Hence, any modified embodiments should also be protected in the present invention.

1. A multiple description video coding method based on rotation, characterized in that said method includes the following steps:
extracting one frame f from the video sequence;
carrying out a symmetric transform on the frame f, encoding it with H.264 to form a description 1; and
encoding the original frame f directly with H.264 to form a description 2.

2. The multiple description video coding method based on rotation as claimed in claim 1, characterized in that said symmetric transform uses the center of image as the symmetric point to carry out the center symmetry transformation, uses the vertical center axis as the symmetric axis to carry out the symmetry transformation, or uses the horizontal center axis as the symmetric axis to carry out the symmetry transformation.

3. The multiple description video coding method based on rotation as claimed in claim 1, characterized in that said method further includes the following sub-steps:
getting a reconstructed frame f′ of the description 1 and carrying out an inverse symmetric transformation, then averaging the transformed frame with the reconstructed frame f″ of the description 2;
subtracting the original frame f from the averaged frame to get residuals;
encoding the residuals with H.264; then
subsampling the residual from even/odd parts so as to form a description 3 and a description 4, respectively.

4. A multiple description video decoding method based on rotation, characterized in that said method includes:
if two packets of the same image content, which belongs to the two descriptions, are not all lost, carrying out the reconstructed pixel of the received packet to replace the lost one, in which the displayed pixels at a decoding side are the average values of the two descriptions; and both of the two descriptions use their original corresponding reference image to decode; or
if both the packets of the same image content in the two descriptions are lost, carrying out a default concealment technique in H.264 to reconstruct the pixels at the decoding side, in which the displayed pixels are still the average ones of the two descriptions, and the reference image is changed as the average reconstructed one for both of the two descriptions.

5. The multiple description video decoding method based on rotation as claimed in claim 4, characterized in that, at the decoding side, the decoding for each of descriptions 1 and 2 are still implemented as claim 4; for description 3 and 4, the decoded residuals will be added to the descriptions 1 and 2 respectively to finish the reconstruction.

6. A multiple description video coding apparatus based on rotation, characterized in that the apparatus includes the following modules:
a frame storing module for storing each of frames f from the sequence;
a symmetric transformation module for carrying out the symmetric transformation for each of frames f;
a H.264 module for carrying out the transformation with H.264 for the original frame and the frame after the symmetric transformation;
a description 1 module for storing the description 1 after H.264 transformation; and
a description 2 module for storing the description 2 after H.264 transformation.

7. The multiple description video coding apparatus based on rotation as claimed in 6, characterized in that, the apparatus includes the following modules:
a reconstructed frame f′ module for reconstructing the description 1;
an inverse symmetric transformation module for carrying out the inverse symmetric transformation for the reconstructed frame f′;
a reconstructed frame f″ module for reconstructing the description 2;
an average module for averaging the reconstructed frame f′ and the reconstructed frame f″;
an extracting residuals module for getting the residuals between the outputs of average module and the original frame;
a residual H.264 encoding module for encoding the residuals with H.264;
a data packet subsampling module for subsample the data output from the residual H.264 encoding module in even/odd way;
a description 3 module for storing the odd parts of the output in the subsampling module; and
a description 4 module for storing the even parts of the output in the subsampling module.

8. A multiple description video decoding apparatus based on rotation, characterized in that the apparatus includes the following modules:
a judgment module for checking whether data packets of both of the two descriptions that contain the same content as each other are lost;
a reconstructed module for using the received data packet to replace the lost data packet to reconstruct the lost data packet if the data packets of the two descriptions that contains the same content as each other are not both lost; at the decoding side, the displayed image is the average value of the two descriptions; both of the two descriptions use their original reference frames; on the other hand, if neither of the data packets of the two descriptions that contain the same image content as each other is received, the lost packets are reconstructed with error concealment technique in H.264, while the display at the decoding side is still the average value of the two descriptions, and both of the two descriptions use the average reconstructed frame as the reference.

9. The multiple description video decoding apparatus based on rotation as claimed in 8, characterized in that, the apparatus further includes the following modules:
a residual decoding module for decoding the residual signal; and
an adding module for adding the decoded residual to the description 1 and the description 2.

10. A multiple description video decoding system based on rotation, characterized in that, the system includes the coding apparatus claimed in claims 6 and 7 and the decoding apparatus claimed in claims 8 and 9.
